(19) United States
(12) Patent Application Publication
(10) Pub. No.: US 2010/0264825 A1
(43) Pub. Date: Oct. 21, 2010

(54) ION SOURCE FOR GENERATING A PARTICLE BEAM

(76) Inventor: THOMAS UHL, Lohra (DE)

Correspondence Address: BRINKS HOFER GILSON & LIONE, P.O. BOX 10395, CHICAGO, IL, 60610, US

(21) Appl. No.: 12/758,376

(22) Filed: Apr. 12, 2010

(30) Foreign Application Priority Data
Apr. 16, 2009 (DE) DE 10200901 647.0

(51) Int. Cl. H01J 27/02

(52) U.S. Cl. 315/111.91; 313/362.1; 313/231.01

(57) ABSTRACT

An ion source for generating a particle beam includes a plasma chamber and an electrode, which extends up to the plasma chamber. A gas that is to be ionized is introduced into the ion source via a gas line, which extends over the entire length of the electrode in parallel with the electrode such that the gas flows out of the gas line in immediate proximity to an entry to the plasma chamber.

This application claims the benefit of DE 10 2009 017 647.0 filed Apr. 16, 2009, which is hereby incorporated by reference.

### BACKGROUND

The present embodiments relate to an ion source for generating a particle beam and an electrode for such an ion source.

In a particle therapy treatment (e.g., of cancers), a particle beam including, for example, protons or heavy ions (e.g. carbon ions) is generated. The particle beam is generated in an acceleration system and guided into a treatment room where the particle beam enters via an exit window. The particle beam may be directed into different treatment rooms in alternation by the acceleration system. In the treatment room, a patient who is to receive the therapy is positioned (e.g., on a patient examination table) and where appropriate, is immobilized.

In order to generate the particle beam, the acceleration system includes an ion source such as, for example, an electron cyclotron resonance ion source (ECR ion source). In the ion source, a directed movement of free ions having a specific energy distribution is generated, the exit energy of the ions being very precise. In this case, positively charged ions, such as protons or carbon ions, are used for irradiating certain tumors. The positively charged ions can be driven to high energy with the aid of the accelerator and release energy in the body tissue in a very precise manner. The particles generated in the ion source circulate in a circular accelerator in an orbit at more than 50 MeV/u, for example. A pulsed or continuous particle beam having predefined energy, focusing and intensity is provided for the therapy.

The ion source includes a plasma chamber, in which a vacuum exists, for ionizing an operating gas. Arranged concentrically around the plasma chamber are permanent magnets, which form and hold the plasma. The gas that is to be ionized is injected into the plasma chamber via a connecting part. Free electrons in the plasma chamber, which ionize the injected gas, are accelerated using microwave radiation. The microwave radiation is introduced into the plasma chamber via a waveguide arranged in the connecting part. An electrode (e.g., a bias electrode) also runs through the connecting part in the direction of the plasma chamber. The electrode is negatively charged with respect to a housing of the plasma chamber and repels the free electrons from the plasma chamber, confining the free electrons inside the plasma chamber. The electrons generate the ions (the plasma) inside the plasma chamber using collision ionization.

A coupling cylinder, on which a tube extends laterally, is disposed on the connecting part at right angles to the electrode. The gas that is to be ionized reaches the connecting part through the tube via a curved gas line with an outlet directed toward the connecting part, and from there, passes via the waveguide into the plasma chamber. A vacuum pump is provided on the coupling cylinder in order to guide the gas, which does not reach the plasma chamber, through.

The described arrangement for introducing gas into the plasma chamber has a number of drawbacks. The diameter of the gas line varies very widely in the different sections, resulting in the formation of dead zones for the gas flow. Since the residence time of some gas particles is significantly extended as a consequence, the switchover from one operating gas to another can take several minutes. Also, the gas from the gas line is introduced into the coupling cylinder directly via the vacuum pump, with the result that a large part of the gas is aspirated and does not reach the plasma chamber. The proportion of the gas that reaches the plasma chamber is dependent on the efficiency of the vacuum pump and is estimated.

### SUMMARY AND DESCRIPTION

The present embodiments may obviate one or more of the drawbacks or limitations in the related art. For example, in one embodiment, an efficient gas supply and a faster response time when switching over the operating gas of an ion source may be provided.

In one embodiment, an ion source for generating a particle beam includes a plasma chamber and an electrode, which extends up to the plasma chamber. A gas line for a gas that is to be ionized runs over the entire length of the electrode in parallel with the electrode.

The electrode is a bias electrode, which is negatively charged with respect to the ion source voltage, and is used to repel the electrons that are released in the plasma chamber.

The present embodiments are based on the consideration that a particularly efficient gas supply is present when the gas that is to be ionized is introduced far into the ion source such that the gas flows out from the gas line in the immediate vicinity of the plasma chamber. Consequently a very large proportion of gas particles reach the plasma chamber. The gas is not introduced “from below” via a coupling cylinder for a vacuum pump. Instead, the gas line is introduced from a different side, namely in the region of the electrode and inside the ion source, running in a straight line parallel to the electrode, (i.e., the gas flow flows in a deflection-free manner inside the ion source). Because the gas line is rectilinear, the gas line is particularly easy to implement technically and introduce into the ion source. In one embodiment, the gas line has an essentially constant cross-section such that no dead zones are produced. The gas line runs along the entire length of the electrode, with the result that the gas flow is introduced at least as deep into the ion source as the electrode extends. In this arrangement, the gas line discharges in immediate proximity to the plasma chamber, so the gas supply is not adversely affected by the operation of the vacuum pump, and consequently, the efficiency of the ions generated from the admitted gas is significantly improved.

In one embodiment, the gas line runs inside an electrode tube. Since the electrode is configured substantially as a hollow body, a good use of space is achieved in that the gas line is routed inside the electrode tube. In this case no additional openings are provided at the ion source in order to lead the gas line through.

In one embodiment, the gas line is arranged concentrically with respect to the electrode. The electrode extends along an axis of symmetry of the plasma chamber, which results in a good efficiency in the repelling of the electrons coming from the plasma chamber. In an arrangement of the gas line concentrically with respect to the electrode, the gas line also runs along the axis of symmetry of the plasma chamber such that the gas can flow centrally into the plasma chamber.

In one embodiment, a deflection free gas flow is realized where the electrode includes a coupling flange with a gas connection port for connecting the gas line to a supply line, the gas connection port being aligned with the gas line. The gas connection port lies on a line with the gas line, and only the separable supply line, via which the gas travels from a gas reservoir to the gas line and consequently reaches the ion source, has bends where necessary.

In one embodiment, a coolant may flow through the electrode tube, the electrode tube having a return line for the coolant. The gas line may be arranged in the return line. For cooling purposes, an electrically non-conducting coolant such as, for example, deionized water or oil, is injected into the electrode tube in the region of the coupling flange. The coolant flows in the direction of an electrode tip adjacent to the plasma chamber. In the region of the electrode tip, an opening of the return line is provided. The coolant flows into the opening of the return line and flows out of the electrode at the other end of the return line in the region of the coupling flange.

In one embodiment, the gas line is arranged concentrically with respect to the enclosing return line, and the return line is arranged concentrically with respect to the electrode tube. In order to establish a uniform temperature distribution in the radial direction of the electrode tube, the return line may be arranged concentrically with respect to the electrode tube. With regard to a symmetrical arrangement of the gas line with respect to the electrode tube, it is advantageous that the gas line is arranged inside the return line.

In one embodiment, the coupling flange includes a first connection for introducing the coolant and a second connection for conducting the coolant out, and the gas connection port is arranged in one of the first and second connections. In this arrangement, no additional holes are provided in the region of the coupling flange for the gas connection port or to introduce the gas line into a connecting piece of the ion source.

In one embodiment, an outlet opening for the gas that is to be ionized is provided at a front end of the electrode tube. The outlet opening is thus directed toward the plasma chamber such that after leaving the electrode tube, the operating gas flows directly and in a deflection-free manner into the plasma chamber.

In one embodiment, the electrode tube includes a replaceable electrode tip, in which the outlet opening is provided. Because the electrode tip may be damaged during operation of the ion chamber as a result of the high temperatures to which the electrode tip is exposed, the electrode tip is replaceable and is secured to the electrode tube using a thread. The electrode tip may have an open front end such that the outlet opening for the gas line configured using the open front end of the electrode tip.

In one embodiment, a coupling piece, in which a hole is provided, is arranged between the electrode tube and the replaceable electrode tip. The electrode tube and the electrode tip both have hollow bodies, and the coupling piece arranged between the electrode tube and the electrode tip may have a solid body. In order to enable the gas flow to be guided through the coupling piece, a hole, which runs centrally, is therefore provided. The flow of the coolant in the longitudinal direction of the electrode is limited by the coupling piece. To prevent the coolant from flowing out of the electrode through the hole, the gas line is in contact with the coupling piece or extends into the inside of the hole, a contact area between the gas line and the coupling piece being sealed.

In one embodiment, an electrode for an ion source, including a coupling flange and an electrode tube, in provided. A gas connection port for a gas line is provided on the coupling flange, the gas line extending over the entire length of the electrode tube.

The advantages and embodiments presented in relation to the ion source are to be applied analogously to the electrode.

Advantageously, the gas line is arranged concentrically with respect to the electrode tube. Also advantageously, the coolant may flow through the electrode tube, and the electrode tube has a return line for the coolant, in which the gas line is arranged.

In one embodiment, a method for introducing a gas that is to be ionized into an ion source for the purpose of generating a particle beam is provided. The ion source includes a plasma chamber and an electrode, which extends up to the plasma chamber. The gas is introduced into the plasma chamber over the entire length of the electrode in parallel with the electrode and inside the electrode.

### BRIEF DESCRIPTION OF THE DRAWINGS

FIG. 1 shows one embodiment of an ion source for generating a particle beam,

FIG. 2 shows an enlarged view of the section II of the ion source according to FIG. 1, and

FIG. 3 shows a cross-section of the ion source according to FIG. 1 along the line III.

### DETAILED DESCRIPTION OF THE DRAWINGS

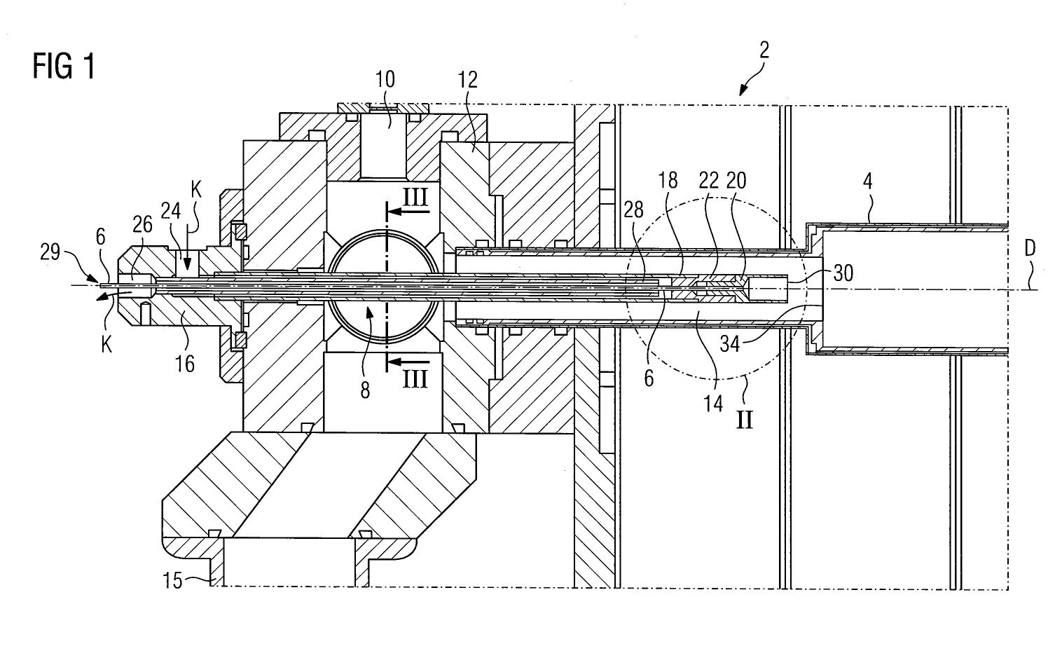

FIG. 1 shows one embodiment of an ion source 2 for generating a particle beam, the ion source 2 being part of a particle therapy system (not shown in further detail). The ion source 2 includes a plasma chamber 4, in which the particle beam is generated through ionization of an operating gas. The operating gas that is to be ionized is introduced into the plasma chamber 4 using a gas line 6. The gas line 6 extends along an electrode 8, which is provided for the purpose of repelling the free electrons in the plasma chamber 4. In order to ionize the operating gas, microwave radiation is also introduced into the plasma chamber 4. The microwave radiation is introduced through a microwave connection port 10, into a connecting part 12 and supplied to the plasma chamber 4 via a waveguide 14, in which the electrode 8 containing the gas line 6 also extends.

Provided opposite the microwave connection port 10 on the connecting part 12 is a pump connection 15 for a vacuum pump, which aspirates gas particles from the cavities of the connecting piece.

The electrode 8 includes a coupling flange 16 that is used to secure the electrode 8 to the connecting part 12 and a hollow electrode tube 18, which extends up to the plasma chamber 4. The electrode 8 also includes a replaceable electrode tip 20, which is screwed into a coupling piece 22 and consequently is secured to the electrode tube 18 using the coupling piece 22.

During operation of the ion source 2, the electrode 8 is continuously cooled with the aid of a coolant (e.g., cooling water), which is indicated using the arrows K. A first connection 24 is provided on the coupling flange 16 for the purpose of introducing the cooling water K. The cooling water K is conducted out of the electrode 8 through a second connection 26. The introduced cooling water K flows along an inner circumferential wall of the electrode tube 18 until the cooling water K has reached the coupling piece 22. A return line 28, through which heated coolant K is routed to the second connection 26, runs concentrically with respect to the electrode tube 18. The gas line 6 is arranged inside the return line 28 and runs in a straight line between a gas connection port 29, which may be connected to a separate supply line for supplying the gas from a gas reservoir (not shown), and the coupling piece 22 at the distal end of the electrode 8.

As shown in FIG. 3, the electrode tube 18, the return line 28 and the gas line 6 are arranged concentrically with respect to one another. The electrode tube 18 also runs concentrically with respect to the waveguide 14, such that the gas line 6 extends along an axis of symmetry D of the plasma chamber 4. In this arrangement, the gas is introduced centrally into the plasma chamber, such that a high degree of symmetry is present during the generation of the plasma. Symmetry is important for a stable particle beam.

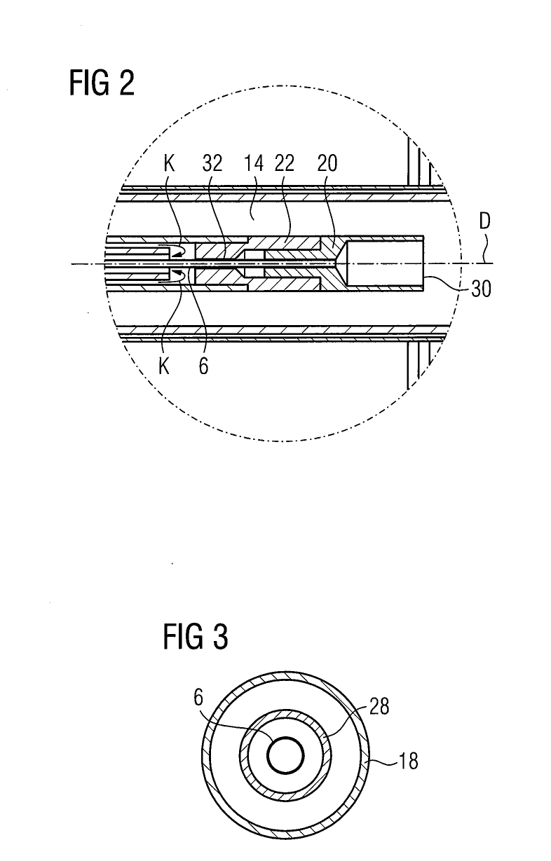

The precise layout and the arrangement of the gas line 6 in the region of the electrode tip 20 are shown in the enlarged view depicted in FIG. 2. Parts equivalent to one another and functioning in the same way are labeled by the same reference signs in all of the figures.

In one embodiment, the electrode tip 20 is hollow and has an open front end, which forms an outlet opening 30 for the gas. A hole 32 is embodied in the coupling piece 22 to enable the gas flow to reach the hollow electrode tip 20. The region in which the gas line 6 enters into the coupling piece 22 is sealed in a waterproof manner so that the coolant K does not flow into the hole 32.

In the embodiment shown, the gas line 6 runs in a straight line and has an essentially constant cross-section over entire length of the gas line 6 up to the electrode tip 20. The gas that is to be ionized may thus be introduced into the ion source 2 free of deflections. Owing to the embodiments of the gas line 6 described above, no dead zones are produced in which gas particles can reside for relatively long periods of time. A switchover of the operating gas (e.g., from carbon dioxide to hydrogen) may therefore be performed very quickly, and a constant gas flow and consequently a stable particle beam will be established after short periods of time (e.g., a few seconds).

A further advantage of the gas line 6 described above is that the gas line extends far into the interior of the ion source 2, up to in front of an entry 34 to the plasma chamber 4. As a result, the gas particles reach the plasma chamber 4 undisrupted by the vacuum pump.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An ion source for generating a particle beam, the ion source comprising:
a plasma chamber; and
an electrode, which extends up to the plasma chamber,
wherein a gas line for a gas that is to be ionized extends over the entire length of the electrode in parallel with the electrode.

2. The ion source as claimed in claim 1, wherein the gas line runs inside an electrode tube.

3. The ion source as claimed in claim 2, wherein the gas line is arranged concentrically with respect to the electrode tube.

4. The ion source as claimed in claim 2, wherein the electrode comprises a coupling flange having a gas connection port for connecting the gas line to a supply line, the gas connection port being aligned with the gas line.

5. The ion source as claimed in claim 2, wherein a coolant flows through the electrode tube, and the electrode tube comprises a return line for the coolant, and
wherein the gas line is arranged and enclosed in the return line.

6. The ion source as claimed in claim 5, wherein the gas line is arranged concentrically with respect to the return line, and the return line is arranged concentrically with respect to the electrode tube.

7. The ion source as claimed in claim 4, wherein the coupling flange comprises a first connection for introducing the coolant and a second connection for conducting out the coolant, and
wherein the gas connection port is arranged in one of the first connection or the second connection.

8. The ion source as claimed in claim 2, wherein the electrode tube comprises an outlet opening for the gas that is to be ionized provided at a front end of the electrode tube.

9. The ion source as claimed in claim 8, wherein the electrode tube further comprises a replaceable electrode tip, in which the outlet opening is included.

10. The ion source as claimed in claim 9, wherein a coupling piece, in which a hole is included, is arranged between the electrode tube and the replaceable electrode tip.

11. An electrode for an ion source, the electrode comprising:
a coupling flange; and
an electrode tube,
wherein a gas connection port is provided on the coupling flange for a gas line, which extends over the entire length of the electrode tube.

12. The electrode as claimed in claim 11, wherein the gas line is arranged concentrically with respect to the electrode tube.

13. The electrode as claimed in claim 11, wherein a coolant flows through the electrode tube, and the electrode tube comprises a return line for the coolant, and
wherein the gas line is arranged in the return line.

14. A method for introducing a gas that is to be ionized into an ion source for the purpose of generating a particle beam, the method comprising:
introducing the gas into a plasma chamber of the ion source over the entire length of and in parallel with an electrode, which extends up to the plasma.

15. The ion source as claimed in claim 1, wherein the electrode comprises a coupling flange having a gas connection port for connecting the gas line to a supply line, the gas connection port being aligned with the gas line.

16. The ion source as claimed in claim 3, wherein the electrode comprises a coupling flange having a gas connection port for connecting the gas line to a supply line, the gas connection port being aligned with the gas line.

17. The ion source as claimed in claim 4, wherein a coolant flows through the electrode tube, and the electrode tube comprises a return line for the coolant, and
wherein the gas line is arranged and enclosed in the return line.

18. The ion source as claimed in claim 5, wherein the electrode tube comprises an outlet opening for the gas that is to be ionized provided at a front end of the electrode tube.

19. The ion source as claimed in claim 6, wherein the electrode tube comprises an outlet opening for the gas that is to be ionized provided at a front end of the electrode tube.

20. The electrode as claimed in claim 12, wherein a coolant flows through the electrode tube, and the electrode tube comprises a return line for the coolant, and
wherein the gas line is arranged in the return line.
